(19) United States
(12) Patent Application Publication
(10) Pub. No.: US 2006/0022124 A1
(43) Pub. Date: Feb. 2, 2006

(54) System and method for automated testing of optical characteristics of a light-emitting element

(75) Inventor: Charles Chuang, Taoyuan Hsien (TW)

Correspondence Address: BIRCH STEWART KOLASCH & BIRCH, PO BOX 747, FALLS CHURCH, VA, 22040-0747, US

(73) Assignee: Chroma Ate Inc.

(21) Appl. No.: 11/192,274

(22) Filed: Jul. 29, 2005

(30) Foreign Application Priority Data
Jul. 29, 2004 (TW) 93122634

(51) Int. Cl. G01B 9/10

(52) U.S. Cl. 250/227.28

(57) ABSTRACT

In a system and method for automated testing of optical characteristics of a light-emitting element, an optical characteristic capturing device continuously rotate about the light-emitting element to be tested at a fixed radius while constantly facing the light-emitting element. The path of rotation is divided into a measuring section and a non-measuring section. The non-measuring section is utilized to enable rotation of the element to be tested or replacement of the element to be tested, thereby simplifying operational states of a support device of the capturing device. Not only can this work with an automated process to perform continuous testing of elements, the overall structure of the testing system can be simplified, and the operation there of can be sped up. Besides, measurement of wide angles can be conducted with accuracy. Thus, the marketplace's requirement for an instrument for high-speed testing of light-emitting elements can be fully met.

### CROSS-REFERENCE TO RELATED APPLICATION

This application claims priority of Taiwanese Application No. 93122634, filed on Jul. 29, 2004.

### BACKGROUND OF THE INVENTION

1. Field of the Invention

The invention relates to an automated testing system and method, more particularly to a system and method for testing optical characteristics of a light-emitting element.

2. Description of the Related Art

Production values of light-emitting diodes (LEDs) have grown considerably in recent years, and Light-emitting diodes have been extensively used in consumer electronic products, car lighting, traffic lights, etc. Moreover, with the awareness of energy conservation and environmental protection, wide attention has been paid to light-emitting diodes, which have power-saving and environmental-friendly characteristics. However, in view of the ever-increasing market demand, keen market competition, and the requirements of the industry to develop high yield, high power, and high speed process, technology upgrade is not the only bottleneck. Key to product differentiation is beyond functionality and price, but also including product quality. For example, a lighting fixture incorporating many LEDs have its quality strongly associated with the color and brightness uniformity of all the LEDs in the fixture.

The market demands LEDs be tested as a complete optical lighting system beyond basic characteristics. Light emission profile, spectral variation profile, packaging Lens defect, are all to be tested. Similar tests are also required of laser diodes, organic light emitting diodes and other light emitting devices.

As shown in FIG. 1, the measurement of changes in color and brightness at different angles in a conventional testing system is to place an optical measuring instrument 12 on an angle measuring instrument (goniometer) 1, and measurement of a light-emitting diode 2 to be tested, which is disposed on a securing seat 11, is conducted by manual or motor-driven operation. However, since the result of measurement obtained by the optical measuring instrument 12 is transmitted via a transmission line 13 having a fixed length, when the optical measuring instrument 12 reaches an extreme limit of the transmission line 13, it has to be turned in a reverse direction. The angle measuring instrument 1 is thus limited in terms of the range of angle measurement. Moreover, as the primary objective of the angle measuring instrument 1 is angle precision, in addition to movement, consideration has to be particularly given to a reduction in speed and halting on approaching the turning point, and an increase in speed in the reverse direction. Thus, the speed of movement of the angle measuring instrument 12 as a whole is too slow. Current systems required several minutes to test one device, good enough for sampling test, but cannot be deployed onto the production line, therefore cannot effectively control product quality.

There is available another testing system which achieves high production capacity by automation. Reference is made to Taiwanese Patent Publication No. 553389 for “Automated structure for light-emitting diode testing machine,” which utilizes a fixed detection head to perform testing of a light-emitting diode disposed correspondingly below the detection head, thereby permitting fast in/out rotation of the device under test. Since the light-emitting source of a conventional light-emitting diode is generally not located at the center of the packaging, testing of the light-emitting diode from a single position in the aforesaid testing method will result in serious errors if the testing position deviates from the primary optical axis on the one hand, and even if the optical axis is aligned during measurement, important data, such as the radiation pattern, still cannot be obtained. Moreover, uniformity of optical characteristics of the light-emitting diode at each angle cannot be ensured. Therefore, although the conventional testing system can increase the speed of measurement, it cannot provide the same good inspection quality.

### SUMMARY OF THE INVENTION

Therefore, an object of the present invention is to provide a highly efficient method for automated testing of optical characteristics of a light-emitting element.

Another object of this invention is to provide a method for automated testing of optical characteristics of a light-emitting element at various angles.

Still another object of this invention is to provide a system for automated testing of optical characteristics of a light-emitting element, which has a support device that is simple in construction.

Yet another object of this invention is to provide a system for automated testing of optical characteristics of a light-emitting element, which is capable of high-speed measurement.

A further object of this invention is to provide a system for automated testing of optical characteristics of a light-emitting element, which is capable of extensive angle measurement.

Accordingly, the testing method of this invention includes: a) enabling a light-emitting element to remain at a test region for a predetermined period of time; b) enabling a first optical characteristic capturing device to continuously rotate at a fixed radius while constantly facing the test region, and dividing a rotational path of the first optical characteristic capturing device according to optical characteristics of the light-emitting element into a measuring section capable of measuring the optical characteristics and a non-measuring section; and c) causing the first optical characteristic capturing device to move to the measuring section and to record the optical characteristics measured by the first optical characteristic capturing device.

The testing system of this invention includes a rotary device and a first optical characteristic capturing device. The rotary device includes a support unit that continuously rotates about an axis passing through a test region. The first optical characteristic capturing device is secured on the support unit to be able to constantly face the test region for measuring optical characteristics of a light-emitting element. The first optical characteristic capturing device rotates about a rotational path that is divided into a measuring section capable of measuring optical characteristics and a non-measuring section according to the optical characteristics of the light-emitting element.

### BRIEF DESCRIPTION OF THE DRAWINGS

Other features and advantages of the present invention will become apparent in the following detailed description of the preferred embodiments with reference to the accompanying drawings, of which:

FIG. 1 is an assembled perspective view of a conventional system for testing optical characteristics of a light-emitting element, illustrating the use of an angle measuring instrument to conduct testing of the light-emitting element;

FIG. 2 is a side view of the first preferred embodiment of a system for automated testing of optical characteristics of a light-emitting element according to this invention;

FIG. 3 is a front view of FIG. 2;

FIG. 4 is a flowchart of a preferred embodiment of a method for automated testing of optical characteristics of a light-emitting element according to this invention;

FIG. 5 is a graph illustrating the relationship of the angle of a first optical characteristic capturing device and the angles of a light-emitting element relative to time; and

FIG. 6 is an assembled side view of the second preferred embodiment of a system for automated testing of the optical characteristics of a light-emitting element according to this invention, illustrating a support unit and a rotary disk.

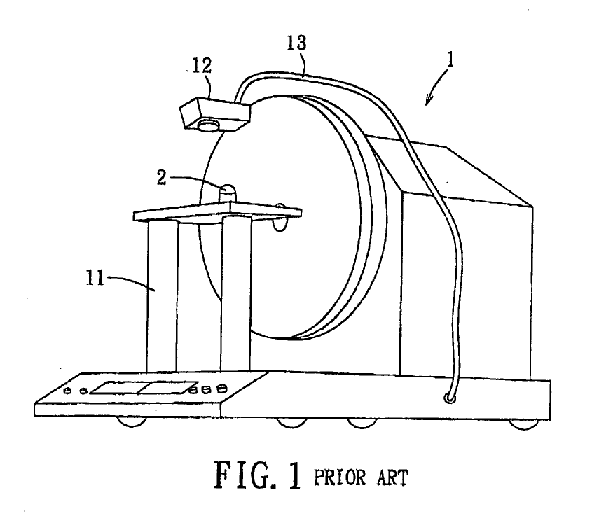

### DETAILED DESCRIPTION OF THE PREFERRED EMBODIMENTS

Before the present invention is described in greater detail, it should be noted that like elements are denoted by the same reference numerals throughout the disclosure.

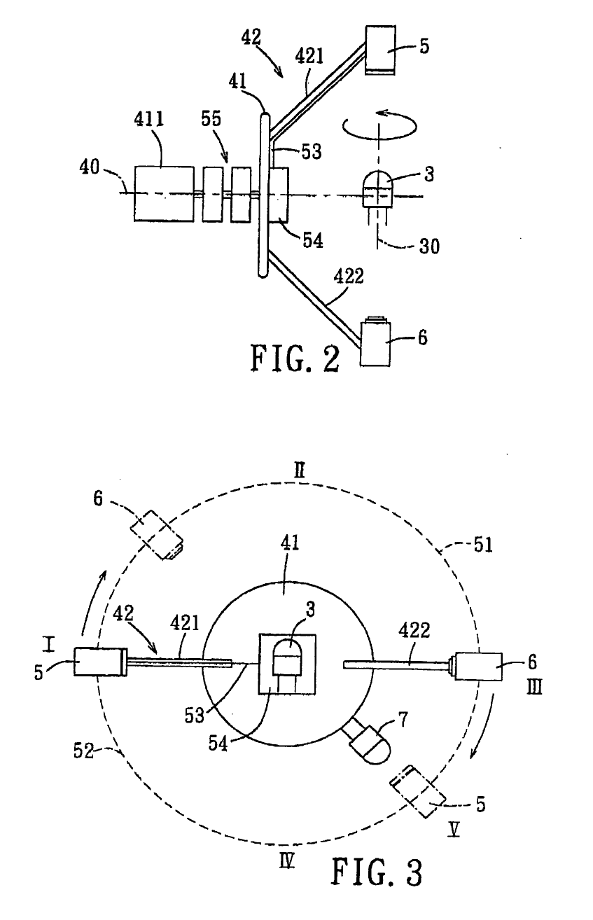

As shown in FIG. 2, the first preferred embodiment of a system for automated testing of optical characteristics of a light-emitting element according to this invention is used to conduct testing of a light-emitting element 3 that moves via a feeding device (not shown) in an automated process. The light-emitting element 3 in this preferred embodiment is a light-emitting diode. The feeding device may convey a light-emitting element 3 to be tested to a test region by traveling along a straight line or in a reciprocating manner. The testing system includes a rotary device 4, a first optical capturing device 5, a second optical capturing device 6, a calibrating device or target 7, and a position reading device (not shown).

The rotary device 4 includes a rotary body 41 that is arranges at some distance away from the test region along an axis 40, and a support unit 42 that extends from the rotary body 41 and that is driven by a drive motor 411 to continuously rotate about the axis 40. The support unit 42 includes a first rotary arm 421 and a second rotary arm 422 that is symmetrical to the first rotary arm 421 in position.

The first optical characteristic capturing device 5 is secured on the first rotary arm 421 to be able to constantly face the test region, and is used to measure the optical characteristics, such as color spectrum or luminance of the light-emitting element 3. Referring to FIG. 3, a rotational path of the first optical characteristic capturing device 5 is divided according to the optical characteristics of the light-emitting element 3 into a measuring section 51 capable of measuring the optical characteristics and a non-measuring section. The first optical characteristic capturing device 5 in this preferred embodiment includes a measuring instrument 54 having a light guiding unit 53, and a mercury switch 55 for continuous transmission of the analytical results of the measuring instrument 54. The light guiding unit 53 in this preferred embodiment is an optical fiber with an externally added optical element, and may be an optical fiber with an externally added diffuser or integrating sphere in actual practice. A spectrometer or a photosensitive device may be selected for use as the measuring instrument 54 in practice.

The second optical characteristic capturing device 6 in this preferred embodiment is a camera or photometer, which is secured on the second rotary arm 422 so as to be able to constantly face the test region. The second optical characteristic capturing device 6 is used to capture an image of the light-emitting element 3 for analyzing the seating of the die within the package or a photometer for color goniometry. Take the light-emitting element diode as an example.

Referring to FIG. 3, the calibrating device 7 in this preferred embodiment is a standard optical reference element, such as a Tungsten Halogen Radiometric Calibration Standard or a Mercury and Argon Calibration Source that is used to calibrate the first optical characteristic capturing device 5 which are related to the optical characteristics, such as spectral distribution or luminance intensity.

In addition, the system for automated testing of the optical characteristics of a light-emitting element according to this invention further includes a position reading device (not shown) provided on the rotary device 4 for reading the position of the first optical characteristic capturing device 5 on the rotational path, such as an optical ruler.

As shown in FIG. 6, the second preferred embodiment of a system for automated testing of the optical characteristics of a light-emitting element according to this invention differs from the first preferred embodiment in that the support device 42 in the second preferred embodiment is a rotary disk, and the first and second optical characteristic capturing devices 5, 6 are provided symmetrically on the surface to the support device 42.

It is noted that, according to product testing requirements, the aforesaid testing system may dispense with the second optical characteristic capturing device 6 and the second rotary arm 422, or the calibrating device 7, to be independently fabricated and sold so as to save costs. When the second rotary arm 422 is dispensed with, in order to reduce generation of vibration and wear of the rotary body 41 due to unbalanced weights, a suitable counter balancing weight may be mounted on the support device 42.

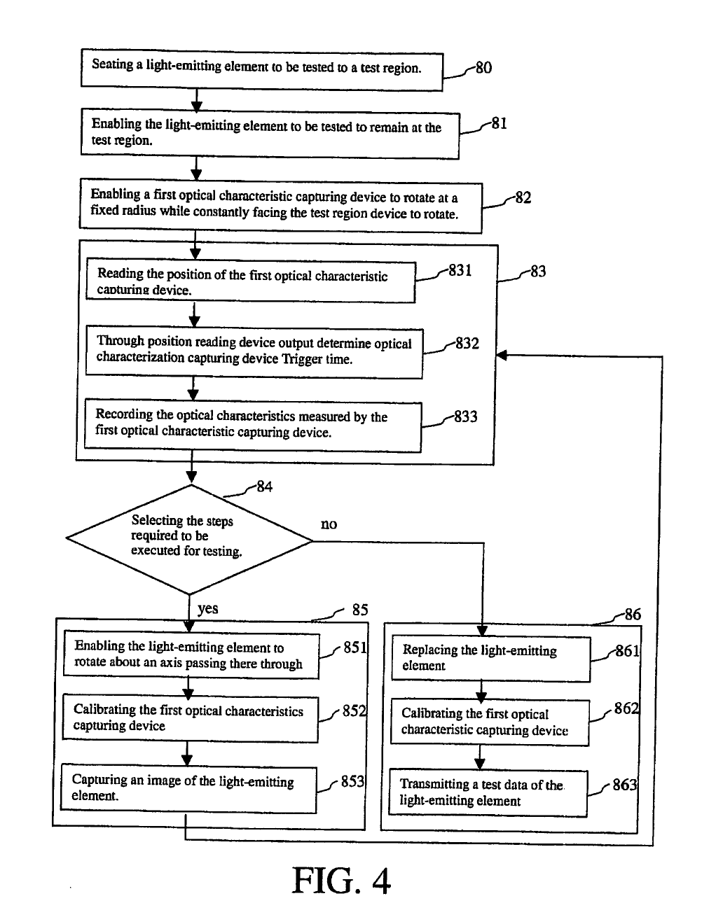

As shown in FIGS. 2, 3 and 4, a method for automated testing of the optical characteristics of the light-emitting element 3 is performed by way of the first and second preferred embodiments, and includes steps 80-86.

In step 80, the light-emitting element 3 to be tested is seated to the test region along a straight line or in a reciprocating manner by an automated device or by hand.

In step 81, the light-emitting element 3 is retained in the test region for a predetermined period of time such that it is in a stationary state relative to the first optical characteristic capturing device 5. In actual application, the speed of movement of the light-emitting element 3 can be reduced such that it is substantially stationary relative to the first optical characteristic capturing device 5.

In step 82, the first optical characteristic capturing device 5 is disposed to constantly face the test region at a fixed radius so as to continuously rotate in a plane, and the rotational path of the first optical characteristic capturing device 5 is divided into the measuring section 51 and the non-measuring section 52 in the above-described manner. When the first optical characteristic capturing device 5 proceeds to the measuring section 51, step 83 is executed.

Step 83 includes sub-steps 831, 832 and 833 that are executed in sequence. In sub-step 831, the position reading device is used to read the position of the first optical characteristic capturing device 5 at the measuring section 51. In sub-step 832, the position reading device output is used to determine the trigger time for the first optical characteristic capturing device 5, the position reading device and trigger for example, can be a fixed position opto mechanical sensor. In sub-step 833, the optical characteristic measured by the first optical characteristic capturing device 5 at each degree is recorded. Of course, the person who skilled in the art can easily recognize that sub-step 832 can be omitted. Fartheremore, when sub-step 832 is omitted, sub-step 831 and sub-step 833 execution sequence can be interchanged without diminishing the desired effort of this invention.

In step 84, when the first optical characteristic capturing device 5 proceeds the non-measuring section 52, a determination is made as to whether step 85 is to be executed or step 86 is directly executed depending on the testing requirements.

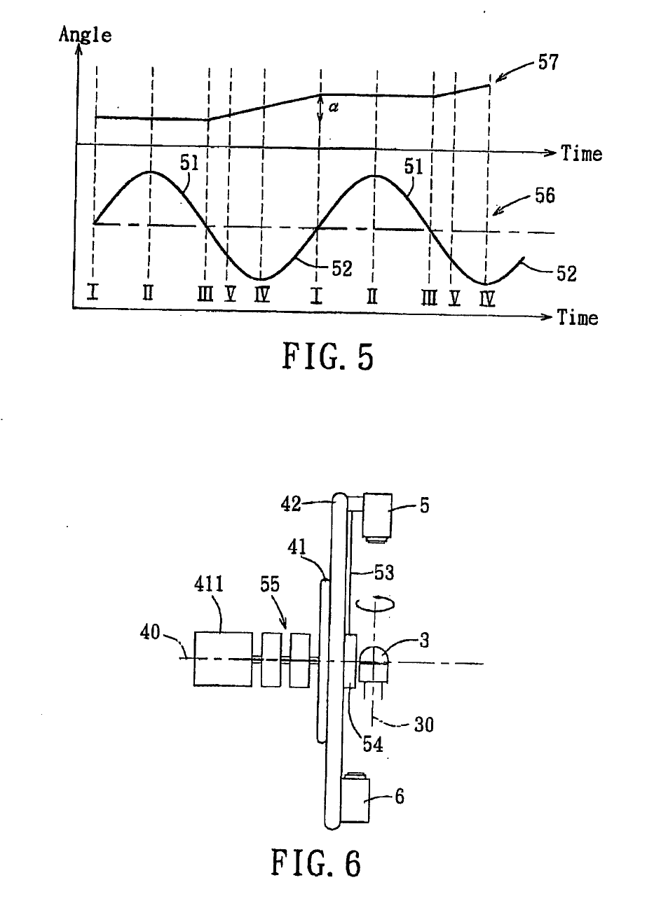

Step 85 includes sub-steps 851, 852, 853 that are executed in sequence. In sub-step 851, the light-emitting element 3 is rotated a predetermined angle a about an axis 30 that passes through the light-emitting element 3 and that is parallel to the plane. Referring to FIG. 5, 56 denotes the angle of rotation of the first optical characteristic capturing device 5 during movement, and the recurring numbers I, II, III, IV, and V respectively represent the different positions of the first optical characteristic capturing device 5 on the track of movement. 57 indicates that the light-emitting element 3 rotates an angle α only when the first optical characteristic capturing device 5 moves to the non-measuring section 52. In sub-step 852, the first optical characteristic capturing device 5 is calibrated using the calibrating device 7. In sub-step 853, the second optical characteristic capturing device 6 is used to capture an image of the light-emitting element 3.

Step 86 includes sub-steps 861, 862, and 863 that are executed in sequence. In sub-step 861, the light-emitting element 3 is replaced. Sub-step 862 is the same as sub-step 852. In sub-step 863, the data captured in the first optical characteristic capturing device 5 can be transmitted out. Of course, the execution sequence of sub-steps 861, 862 and 863 can be interchanged without diminishing the desired effect of this invention.

It is noted that the aforesaid testing method is used in conjunction with the structural elements of the first preferred embodiment in actual use. When the first preferred embodiment does not include the position reading device, sub-step 832 is not executed. When the first preferred embodiment does not include the calibrating device 7, sub-steps 852 and 862 are not executed. When the first preferred embodiment does not include the second optical characteristic capturing device 6, sub-steps 853 and 863 are not executed.

In sum, the system and method for automated testing of optical characteristics of a light-emitting element according to this invention utilizes the first optical characteristic capturing device 5 that continuously rotates about the light-emitting element 3 so that the light-emitting element 3 can be selectively rotated or replaced during the testing process, thereby achieving a testing method that can ensure high-quality and that has high production capacity. Thus, the objects of this invention can be achieved.

While the present invention has been described in connection with what is considered the most practical and preferred embodiments, it is understood that this invention is not limited to the disclosed embodiments but is intended to cover various arrangements included within the spirit and scope of the broadest interpretations so as to encompass all such modifications and equivalent arrangements.

What is claimed is:

1. A method for automated testing of optical characteristics of a light-emitting element, which is adapted to test a light-emitting element, said method comprising:
a) enabling the light-emitting element to remain at a test region for a predetermined period of time;
b) enabling a first optical characteristic capturing device to continuously rotate at a fixed radius while constantly facing the test region, and dividing a rotational path of the first optical characteristic capturing device according to optical characteristics of the light-emitting element into a measuring section capable of measuring the optical characteristics and a non-measuring section incapable of measuring the optical characteristics; and
c) causing the first optical characteristic capturing device to record the optical characteristics measured by the first optical characteristic capturing device upon moving to the measuring section.

2. The method as claimed in claim 1, wherein, in step b), the first optical characteristic capturing device rotates in a plane, said method further comprising a step d) of enabling the light-emitting element to rotate a predetermined angle about an axis that passes through the light-emitting element and that is parallel to the plane when the first optical characteristic capturing device moves to the non-measuring section, and repeating step c).

3. The method as claimed in claim 1, wherein said method further comprises a step e) of replacing the light-emitting element with another light-emitting element when the first optical characteristic capturing device moves to the non-measuring section, and repeating steps a), b), and c).

4. The method as claimed in claims 2, wherein step d) or e) further includes calibrating the first optical characteristic capturing device.

5. The method as claimed in claims 3, wherein step d) or e) further includes calibrating the first optical characteristic capturing device.

6. The method as claimed in claim 1, wherein step c) further includes causing a second optical characteristic capturing device to capture an image of the light-emitting element upon moving to the measuring section.

7. The method as claimed in claim 1, further comprising a step f) of reading the position of the first optical characteristic capturing device.

8. A system for automated testing of optical characteristics of a light-emitting device, which is adapted to test a light-emitting element in an automated process, the automated process defining a test region for testing of the light-emitting element, said system comprising:
a rotary device including a support unit that continuously rotates about an axis passing through the test region; and
a first optical characteristic capturing device secured on said support unit so as to be able to constantly face the test region for measuring optical characteristics of the light-emitting element, said first optical characteristic capturing device rotating about a rotational path that is divided into a measuring section capable of measuring optical characteristics and a non-measuring section incapable of measuring optical characteristics according to the optical characteristics of the light-emitting element.

9. The system as claimed in claim 7, wherein said rotary device further includes a rotary body that is arranged spacedly from the test region along the axis, said support unit including a first rotary arm.

10. The system as claimed in claim 7, wherein said rotary device further includes a rotary body that is arranged spacedly from the test region along the axis, said support unit being a rotary disk with a geometrical center fixed on said rotary body.

11. The system as claimed in claim 7, wherein said first optical characteristic capturing device is a measuring instrument having a light guiding unit.

12. The system as claimed in claim 10, wherein said light guiding unit is an optical fiber with an externally added lens.

13. The system as claimed in claim 10, wherein said light guiding unit is an optical fiber with an externally added translucent lens.

14. The system as claimed in claim 7, wherein said measuring instrument is a thermal image camera.

15. The system as claimed in claim 7, wherein said measuring instrument is a photosensitive element.

16. The system as claimed in claim 7, further comprising a second optical characteristic capturing device provided on said support unit for capturing an image.

17. The system as claimed in claim 15, wherein said second optical characteristic capturing device is a camera.

18. The system as claimed in claim 7, further comprising a position reading device provided on said rotary device for reading the position of said first optical characteristic capturing device.

19. The system as claimed in claim 17, wherein said position reading device is an optical ruler.

20. The system as claimed in claim 7, further comprising a calibrating device for calibrating said first optical characteristic capturing device.

21. The system as claimed in claim 8, wherein said rotary device further includes a weighting device provided on said support unit for reducing vibration and wear of said rotary body.
